(19) United States
(12) Patent Application Publication
(10) Pub. No.: US 2022/0313531 A1
(43) Pub. Date: Oct. 6, 2022

(54) THERAPY DEVICE

(71) Applicant: U-SANA MEDICAL AG, Oberwil (CH)

(72) Inventors: Thomas FÜNFSCHILLING, Biel-Benken (CH); Marco BEFFA, Lüsslingen (CH); Jürg THOMANN, Strengelbach (CH)

(21) Appl. No.: 17/632,887

(22) PCT Filed: Jul. 31, 2020
(86) PCT No.: PCT/EP2020/071736

§ 371 Date: Feb. 4, 2022

(30) Foreign Application Priority Data
Aug. 6, 2019 (CH) 00993/19

(51) Int. Cl. A61H 1/02

(52) U.S. Cl. CPC A61H 1/0266; A61H 2001/027; A61H 2201/1642; A61H 2201/1676; A61H 2201/1215; A61H 2201/5035; A61H 2201/149

(57) ABSTRACT

A therapy device (1) for treating a body part particularly a big toe of a patient, comprises: a base body (2) with a surface (21L, 21R) for receiving a portion of the body of the patient adjacent to the body part; a moving segment (3) having a support surface (321) for receiving the body part; and a drive unit (5) for pivoting the moving segment (3) back and forth relative to the base body (2). The drive unit (5) is fixed to the moving segment (3) and pivotable back and forth relative to the base body (2) together with the moving segment (3).

### TECHNICAL FIELD

The present invention relates to a therapy device according to the preamble of independent claim 1. Such therapy devices comprising a base body with a surface for receiving a portion of a body of a patient adjacent to a body part to be treated, a moving segment having a support surface for receiving the body part, and a drive unit for pivoting the moving segment back and forth relative to the base body, can be used for treating the body part. The body part can particularly be a big toe of a patient.

### BACKGROUND ART

For treating or training body parts for various reasons, devices are known by which body parts can be mobilised in an automated manner. For example, mobilisation of this kind can be important in the postoperative treatment of body parts connected by joints, or in other therapeutic treatment, such as osteoarthritis treatment. In such treatments, it is important to move the joint involved through either an as great angle as possible or an adapted angle, and to look after the body part.

More specifically, in the treatment of big toes, therapy devices are used in which the big toe (hallux) is moved or pivoted relative to the foot or the rest of the foot. The purpose of such therapy devices is to mobilise the big toe or body part to a well-controlled extent and at a well-controlled speed in an automated and gentle manner. Thereby, the nature and extent of the mobilisation is typically adjusted as the treatment progresses.

In this context, US 2018/0243154 A1 discloses a therapy device having a single-piece base plate, a moving segment with a support surface for a body part to be treated, and a drive for pivoting the moving segment back and forth relative to the base plate. The base plate houses the drive unit. It further has a left-side surface and a right-side surface such that the therapy device can be used for treating left and right body parts. In particular, for changing between left- and right-side usage, the moving segment is uncoupled from the base plate, the base plate is flipped around and the moving segment is re-coupled to the base plate the opposite way around.

However, even though such therapy device allows for providing a high efficiency since it can be used for left as well as for right body parts, designing the base plate with a left-side surface and at the same time a right-side surface can be comparably cumbersome. Also, coupling and de-coupling the moving segment can prevent usage of comparably simple drives. For example, when the therapy device has to apply a non-symmetric back and forth pivoting of the moving segment, the drive has to be reconfigured when changing between left-side and right-side use. Also, coupling the moving segment to the drive at two different locations typically requires a comparably sophisticated drive design, typically involving comparably complex mechanics. Furthermore, since the base plate does include the drive, it cannot efficiently be exchanged for example for adjusting size, for hygienic purposes or the like.

Therefore, the object of the present invention is to provide a therapy device that makes it possible to treat a body part by means of mobilisation in an effective, easy-to-handle and flexible manner.

### DISCLOSURE OF THE INVENTION

According to the invention this need is settled by a therapy device as it is defined by the features of independent claim 1. Preferred embodiments are subject of the dependent claims.

In particular, the invention deals with a therapy device for treating a body part particularly a big toe of a patient. The therapy device comprises a base body with a surface for receiving a portion of the body of the patient adjacent to the body part, a moving segment having a support surface for receiving the body part, and a drive unit for pivoting the moving segment back and forth relative to the base body. The drive unit is fixed to the moving segment and pivotable back and forth relative to the base body together with the moving segment.

The therapy device preferably is a mobile therapy device. By being mobile, the therapy device allows for a particularly convenient operation and handling. Also, delivery or supply of the therapy device can be comparably simple and efficient.

In the context of the invention, the term “body part” can refer to body parts in the narrower sense, or portions thereof. Body parts of this kind may, for example, be toes, fingers, hands, arms or parts thereof, such as one or more phalanges. The term can in particular mean the body unit that is to be moved as a whole by means of the therapy device and treated thereby. In particular, the term “body part” can particularly relate to a big toe or hallux.

Furthermore, the body part can be a part of an extremity or limb. In this case, extremities are understood to be body appendages that are moved by muscles and are typically in pairs, such as arms and legs. Extremities can consist of a plurality of body portions and/or body parts.

In the context of the invention, the term “portion of the body adjacent to the body part” can in particular refer to a part or section of the body that includes or adjoins the body part to be treated. Such portions can belong to an extremity. For example, the portion of the body can be a foot if the body part is a toe. It can also be a forearm if the body part is a hand. Or, it can be a hand if the body part is a finger.

The term “receiving” in connection with the surface of the base body and the support surface of the moving segment can relate to accommodating or positioning the portion of the body or the body part, respectively. For example, receiving the big toe as body part can be embodied by positioning the big toe on the support surface of the moving segment such that the latter is contacted by an under side of the big toe.

In relation to the pivotable movement of the moving segment, the term “back and forth” can refer to tipping or tilting in two opposite directions, i.e. clockwise and counter-clockwise. The term can specifically include pivotal up and down movements or the like. Thus, the moving segment can be pivotably moved by, starting from an essentially horizontal position, being upwardly tilted (back) and downwardly tilted (forth) in an alternating manner.

The base body of the therapy device can be a plate like formation. Particularly, when the body part is a big toe or other toe, the base body can be shaped like a plate-like sole. The base body can be equipped with one single surface configured to either receive a left portion of the body or a right portion of the body, or with two separate surfaces, one configured to receive a left portion of the body and the other one configured to receive a right portion of the body. For example, when the base body has the shape of a sole, it can be flipped around such that it can be changed between being suitable for receiving a left or a right foot.

The term “fixed to” in connection with the drive unit and the moving segment relates to being connected to form one piece or a single piece. In particular, when being fixed together, the drive unit and the moving segment are conjointly moved when pivoting the moving segment relative to the base body. Thereby, the drive unit can be mounted to the moving segment. Advantageously, the drive unit is at least partially build in or integrated into the moving segment.

In connection with the drive unit fixed to the moving segment, the terms “one piece” or “single-piece” can refer to a single part design or a multi interconnected part design. Thus, these terms can also cover embodiments in which several parts are interconnected in a fixed manner, for example by an adhesive, rivets, form fit elements and/or screws. Therefore, the drive unit fixed to the moving segment can in particular form a unit that is handled as a whole.

By having the drive unit fixed to the moving segment, these two components form a single unit which can be handled or moved in common. It allows to exclude any drive or similar component to be integrated in the base body. Like this, the base body can be embodied in a comparably simple manner. Thereby, it can be economically exchanged by another or new base body if desired. Further, by having the drive unit included into the moving segment, the structure of the drive unit can be comparably simple since it is not required to induce different movements depending on the left side or right side configuration of the therapy device. The single unit can be compatible for left-side as well as right-side applications or uses. Also from a logistical point of view such single unit can be beneficial since less parts, e.g. two only, need to be provided for supplying therapy devices in all possible configurations. Thus, the therapy device according to the invention allows to treat a body part by means of mobilisation in an effective, easy-to-handle and flexible manner.

Preferably, the therapy device further comprises a mounting structure configured to detachably connect the moving segment to the base body. The term “connect” as used in this context relates to a mounting or coupling of the moving segment to the base body. In particular, when being connected the moving segment is held at the base body in a manner such that it can be pivoted relative to it. By being detachably connected, the moving segment can also be removed from the base body. Particularly, the mounting structure may allows for repeated connection and removal of the moving segment to/from the base body. Like this, the mounting structure allows for conveniently separating the moving segment together with the drive unit from the base body and to remount it to the same or another base body.

Thereby, the base body preferably comprises an axis socket of the mounting structure and the moving segment comprises a rotational axis element of the mounting structure detachably mountable to the axis socket. Particularly, for being mounted and detached, the rotational axis element can be plugged into and pulled out of the axis socket. The rotational axis element can be embodied as a rod or a stick, or being rotationally symmetric or cylindrically shaped. The rotational axis element and the axis socket can be equipped with a latch, engaging or snap-in structure, by which the rotational axis element can be snapped in the axis socket. The drive unit preferably is configured to pivot the moving segment back and forth about the rotational axis element. Such rotational axis element and axis socket allow for a convenient mounting and de-mounting of the moving segment to and from the base body. Furthermore, the drive unit can efficiently pivot the moving segment.

Preferably, the drive unit and the moving segment are embodied as a first part and the base body as a second part. Such two part construction allows for a particularly efficient handling and operation of the therapy device.

Preferably, the therapy device further comprises an energy storage to supply power to the drive unit, wherein the energy storage is integrated in the base body. The energy storage can particularly be a battery or battery pack. Such integrated energy storage allows for efficiently embodying the therapy device as mobile device. This provides for high flexibility in use and operation of the therapy device.

Preferably, the drive unit comprises a servomotor. Such servomotor allows for economically providing the drive unit in a robust way requiring comparably low maintenance.

Preferably, the base body comprises a fastening structure configured to fasten the portion of the body of the patient adjacent to the body part to the base body, when the portion of the body of the patient adjacent to the body part is received on the surface of the base body. Such fastening structure allows for securing the portion of the body at an appropriate position. Like this, correctness of the therapy motion can be assured.

Thereby, the fastening structure preferably has a heel band and an instep band. Advantageously, the bands both are adjustable in length. The term “band” as used herein can relate to a band in the narrow sense as well as to a rope, cord, ligament, strap, brace or similar element. Such bands allow for a safe and convenient fastened positioning of a foot as portion of the body.

Thereby, the instep band preferably is connected at two connection spots on two sides of the base body and extends across the surface of the base body, wherein a distance between the two connection spots is adjustable. Such configuration allows for adapting the base body to the specific needs of the patient.

Preferably, the moving segment comprises a further fastening structure configured to fasten the body part to the moving segment, when the body part is received on the support surface. Such configuration allows for ensuring proper movement of the body part together with the moving segment.

Preferably, the moving segment and the drive unit are configured to downwardly pivot the moving segment to a maximum of about 50° out of a horizontal plane and to upwardly pivot the moving segment to a maximum of about 30°. Such range of motion can allow for particularly efficiently treat a toe or big toe.

Preferably, the therapy device further comprises a controller coupled to the moving segment and configured to control an extent and speed of the movement of the moving segment. Thereby, the controller preferably is configured to select one of plural predefined therapy programs, wherein each therapy program has a specific combination of extent and speed of movement of the moving segment. The controller preferably is magnetically coupled to the moving segment.

Preferably, the moving segment comprises a tilting element and a gliding element, wherein: the drive unit is fixed to the tilting element; the tilting element is connected or connectable to the base body such that it is pivotable back and forth relative to the base body by the drive unit; the gliding element comprises the support surface; and the gliding element is movably mounted to the tilting element. Particularly, the gliding element can be movable to the tilting element such that it can be displaced relative to the tilting element in a direction essentially perpendicular to a rotational axis of the back and forth movement of the moving segment relative to the base body. In order to be movable relative to the tilting element, the gliding element can be mounted via a rail either being embodied at the tilting element or the gliding element. Also, it can be mounted via rolls, balls or the like.

By means of the gliding element, it can be achieved that the rotational axis of the moving segment may be offset from an anatomical axis of the body part to be treated. In particular, the offset may cause the body part to be shifted relative to the tilting element. Like this, the body part can be naturally moved which may increase the quality of the therapy.

### BRIEF DESCRIPTION OF THE DRAWINGS

The therapy device according to the invention is described in more detail herein below by way of an exemplary embodiment and with reference to the attached drawings, in which:

FIG. 1 shows a plan view of an embodiment of a therapy device according to the invention;

FIG. 2 shows a side view of the therapy device of FIG. 1;

FIG. 3 shows a front view of the therapy device of FIG. 1;

FIG. 4 shows a perspective view of some components of the therapy device of FIG. 1;

FIG. 5 shows enlarged detail A of FIG. 4;

FIG. 6 shows a side view of a movement segment including a drive unit of the therapy device of FIG. 1; and

FIG. 7 shows a view along the line E-E of FIG. 6.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

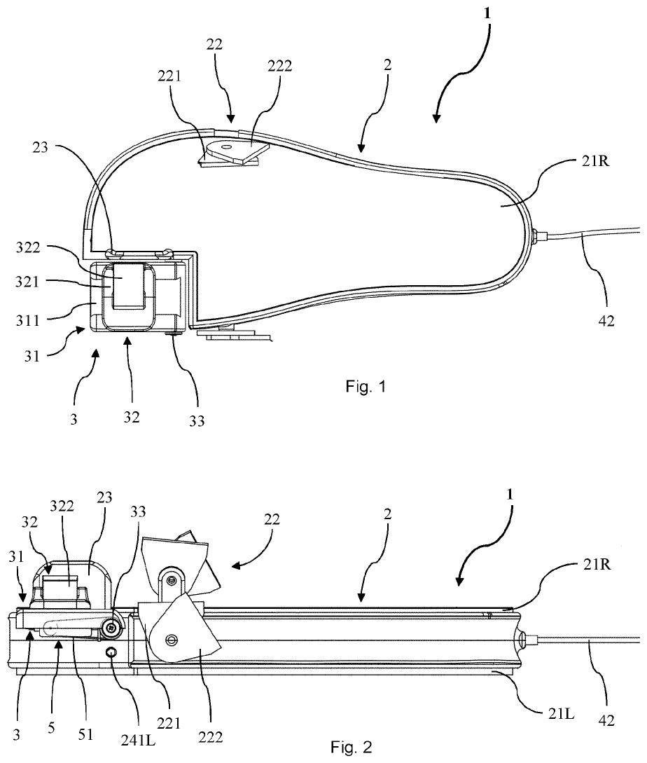

FIG. 1 shows a view on an embodiment of a therapy device 1 according to the invention for treating a big toe of a patient. The therapy device 1 is embodied as a two part assembly. It comprises a base body 2 and moving segment 3. The base body 2 has a right foot surface 21R for receiving a right foot as portion of the body of the patient adjacent to the body part to be treated, i.e. the big toe. More specifically, viewed from above, the base body 2 has a similar shape as a sole of a right shoe, wherein a recess is provided in an area of the big toe.

The base body 2 is equipped with a fastening structure 22 arranged for fastening the right foot of the patient on the right foot surface 21R. The fastening structure has a two heel band holders 222 and two instep band holders 221. A first pair of heel band holder 222 and instep band holder 221 is positioned at a side of the base body 2 near where the ball of the right foot of the patient is to be placed. A second pair of heel band holder 222 and instep band holder 221 is positioned at a side of the base body 2 opposite to the first pair. The two heel band holders 222 are connected by a length adjustable heel band (not visible in the Figs.), and the two instep band holders 221 are connected by a length adjustable instep band (not visible in the Figs.).

In the recess of the base body 2, the moving segment 3 is arranged. As described in more detail below, it comprises a rotational axis element 33 of a mounting structure to be pivotably connected to the base body 2. The moving segment 3 comprises a tilting element 31 and a gliding element 32. The gliding element 32 is arranged in a longitudinal rail groove 311 of the titling element 31 on top of the tilting element 31. The gliding element 32 has a support surface 321 and a toe band 322 of a further fastening structure. By means of the length adjustable toe band 322, the big toe of the patient can be safely fastened to the support surface 321 of the gliding element 32.

The base body 2 is further equipped with a toe separating wall 23. The toe separating wall 23 extends adjacent and along the moving segment 3. It separates the big toe located on the moving segment 3 from the other toes located on the right foot surface 21R of the base body 2. Further, it allows to exactly position the foot of the patient by limiting a frontward movement of the foot when being placed on the therapy device 1.

In FIG. 2 a left side of the therapy device 1 is shown. Thereby, it can be seen that the rotational axis element 33 is mounted to the tilting element 31 of the moving segment 3 by means of a screw. Further, it is depicted that inside the tilting member 31 a drive 5 having a drive belt 51 is arranged.

In the Figs. the therapy device 1 is shown in a zero position or start position. As can be best seen in FIG. 2 in the zero position the moving segment 3 is horizontally orientated such that the big toe can be positioned on the support surface 321 in a non-flexed or straight state.

In addition to the right side surface 21R, the base body 2 has a left side surface 21L. In FIG. 2, the right side surface 21R is the top surface of the base body 2 and the left side surface 21L its bottom side. For changing from the right foot configuration visible in FIG. 2 to a left foot configuration, the base body 2 is to flip around by 180° such that the left side surface 21L forms the top surface and the right side surface 21R forms the bottom surface. Now the base body 2 is ready for receiving a left foot of the patient on the left side surface 21L.

The second pair of heel band holder 222 and instep band holder 221 vertically extends above the first pair of heel band holder 222 and instep band holder 221. Further, the toe separating wall 23 vertically projects above the moving segment 3.

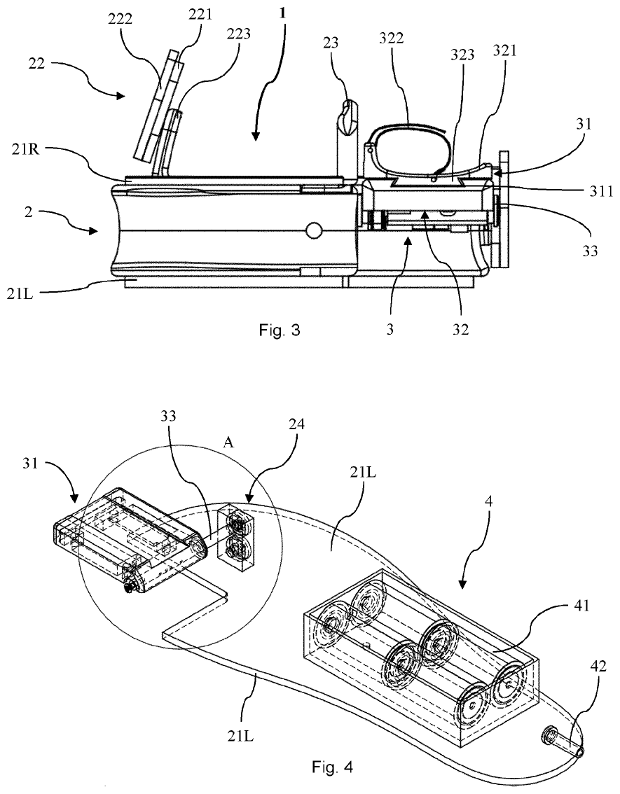

FIG. 3 shows a front of the therapy device 1. Thereby, it can be seen that the second pair of heel band holder 222 and instep band holder 221 is mounted to an instep band slider 223. The slider 223 can be laterally moved relative to the right side surface 21R. Like this, the therapy device 1 can be adapted to a width of the foot of the patient.

As can be seen in FIG. 3, the rail groove 311 of the tilting element 31 of the moving segment 3 upwardly tapers such that it forms an undercut. The gliding element 32 has a rail bar 323 formed at its bottom. The rail bar 323 is shaped in correspondence with the shape of the rail groove 311. In particular, the rail bar 323 being coupled to the rail groove 311 only allows moving the gliding element 32 in one single direction relative to the tilting element 31. More specifically, the by the rail bar 323 engaging the rail groove 311 the gliding element 32 is mounted to the tilting element 31 such that the gliding element 32 can only be straightly moved along the tilting element 31 in a forward direction and in a backward direction of the therapy device 1. In particular, the gliding element 32 can be displaced relative to the tilting element 31 in a direction perpendicular to a rotational axis of the back and forth movement of the moving segment 3 relative to the base body 2 which rotational axis is defined by the rotational axis element 33.

The toe band 322 comprises two portions which can be variably connected to each other. Each of the two portions of the toe band 322 is at one end connected to the support surface 321 of the gliding element 32. Towards their other ends, the portions of the toe band 322 are equipped with a hook and loop fastener. Like this, the toe band 322 can be adjusted in length to suit to the dimension of the specific big toe arranged on the support surface 321.

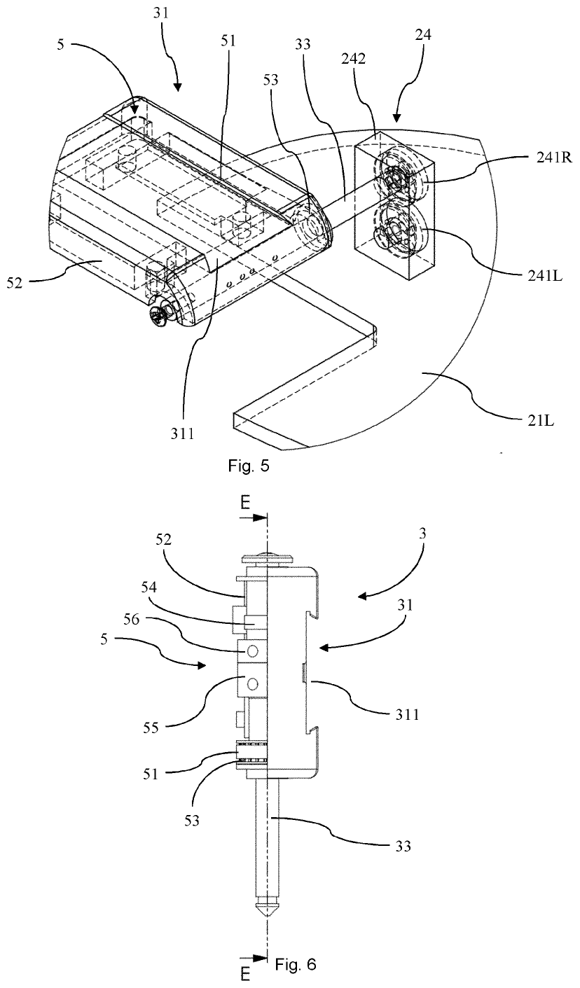

In FIG. 4, the therapy device 1 is partly dismantled such that an energy storage 4 of the therapy device 1 is visible. The energy storage 4 comprises a battery pack 41 and a charging cable 42. The battery pack 41 is arranged inside the base body 2 such that in an assembled state of the therapy device 1 it is not visible. The charging cable 42 is detachably connected at a heel portion of the base body 2 from where it is connected to the battery pack 41 via a cable (not shown in FIG. 4). In use, the battery pack 41 can be charged via the charging cable 42. After the battery pack 41 being charged, the charging cable 42 can be detached such that the therapy device 1 is advantageously mobile.

In the interior of the base body 2, there further is a socket member 24 arranged. The rotational axis element 33 is mounted to the socket member 24 such that the moving segment 3 is held at the base body 2.

More specifically, as can be best seen in FIG. 5, the rotational axis element 33 is generally rod shaped. The socket member 24 comprises a vertical column 242 which is equipped with an upper right side axis socket 241R and a lower left side axis socket 241L. The axis sockets 241R, 241L are equipped with annular springs and the rotational axis element 33 with a circumferential latching notch. When the rotational axis element 33 is moved into one of the axis sockets 241R, 241L, the respective annular spring snaps in the latching notch thereby securing the rotational axis element 33 to the socket member 24.

As indicated by dotted lines, inside the tilting element 31 of the moving segment 3, the drive unit 5 is arranged. The drive unit 5 comprises a servomotor 52, the drive belt 51 and a belt drive wheel 53. The servomotor 52 is coupled to the drive wheel 53 via the drive belt 51. The drive wheel 53 is fixedly mounted to the rotational axis element 33. Thus, the servomotor 52 rotates the rotational axis element 33 via the drive belt 51 and the drive wheel 52 when being operated. In particular, the servomotor 52 is configured to pivot the rotational axis element back and forth when being operated. Like this, the moving segment 3 can be upwardly and downwardly tilted when the servomotor 52 is operated. The servomotor 52 is energized by the battery pack 41 via a cable (not shown in FIG. 5).

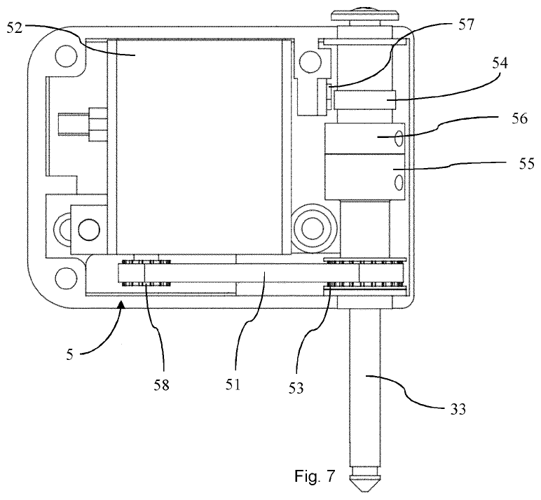

FIG. 6 and FIG. 7 show the tilting element 31 of the moving segment 3 including the drive unit 5 in more detail. In particular, a cover of the tilting element 31 is removed such that its interior and, more particularly, components of the drive unit 5 are visible. Thereby, it can be seen that the servomotor 52 is coupled to a servo drive wheel 58. The drive belt 51 is spanned between the servo drive wheel 58 and the belt drive wheel 53 in a closed loop fashion. Upon operation of the servomotor 52, the servo drive wheel 58 is rotated which forwards the drive belt 51 such that in turn the belt drive wheel 53 is rotated as well. Since the belt drive wheel 53 is coupled to the axis element 33, rotation of the belt drive wheel 53 simultaneously rotates the axis element 33 about its longitudinal axis.

On the axis element 33 a ring shaped magnet 54, a ring shaped drive sleeve 55 and a ring shaped drive sleeve/magnet encoder 56 are mounted in a manner to rotate together with the axis element 33. Between the magnet 54 and the servomotor 52 a magnet encoder circuit 57 is positioned adjacent to the magnet 54.

In use of the therapy device 1 in its shown configuration, the right foot of the patient is positioned on the therapy device 1 such that the right big toe lies on the support surface 321 of the moving segment 3 and the rest of the right foot lies on the on the right side surface 21R of the base body 2. The foot is fastened by means of the heel band and the instep band. By tightening the heel band it can be assured that the foot is correctly longitudinally positioned, i.e. the toe separating wall 23 abuts the foot between the big toe and the long toe. By tightening the instep band, slider 223 is laterally moved until the second pair of heel band holder 222 and instep band holder 221 are correctly laterally positioned. The big toe is then fastened to the moving segment by the toe band 322. Now, the foot is accurately located on the therapy device 1 and ready to receive treatment of the big toe.

For treating the big toe, the drive unit 5 is operated such that the moving segment 3 is pivoted back and forth relative to the base body 2. Thereby, the drive unit 5 itself is conjointly moved together with the moving segment 3. And since the gliding element 32 is movable relative to the tilting element 31 as described above, it can be compensated that the rotational axis of the moving segment is offset from an anatomical axis of the big toe. Like this, the big toe can be naturally moved which increases the quality of the therapy.

By means of the magnet 54, the drive sleeve 55, the drive sleeve/magnet encoder 56 and the magnet encoder circuit 57, a tilting angle of the tilting element 31 is precisely determinable and each rotational position is controllable. Like this, the moving segment 31 can precisely be operated in accordance with a predefined movement and such movement can be monitored.

For preparing the therapy device 1 to be ready for treating a left foot, the moving segment 3 is detached from the base body 2 by pulling the rotational axis element 33 out of the right side axis socket 241R. The rotational axis element 33 is then remounted to moving segment 3 in a reverse orientation such that it extends in an opposite direction from the moving segment 3. The base body 2 is flipped around such that the left side surface 21L is on top and the right side surface is at the bottom. The moving segment 3 is then remounted to the base body 2 by plugging the rotational axis element 33 into the left side axis socket 242L.

This description and the accompanying drawings that illustrate aspects and embodiments of the present invention should not be taken as limiting—the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A therapy device for treating a body part particularly a big toe of a patient, comprising:
a base body with a surface for receiving a portion of the body of the patient adjacent to the body parts;
a moving segment having a support surface for receiving the body part; and
a drive unit for pivoting the moving segment back and forth relative to the base body,
wherein the drive unit is fixed to the moving segment and pivotable back and forth relative to the base body together with the moving segment.

2. The therapy device of claim 1, further comprising a mounting structure configured to detachably connect the moving segment to the base body.

3. The therapy device of claim 2, wherein the base body comprises an axis socket of the mounting structure and the moving segment comprises a rotational axis element of the mounting structure detachably mountable to the axis socket, wherein the drive unit preferably is configured to pivot the moving segment back and forth about the rotational axis element.

4. The therapy device of claim 1, wherein the drive unit and the moving segment are embodied as a first part and the base body as a second part.

5. The therapy device of claim 1, further comprising an energy storage to supply power to the drive unit, wherein the energy storage is integrated in the base body.

6. The therapy device of claim 1, wherein the drive unit comprises a servomotor.

7. The therapy device of claim 1, wherein the base body comprises a fastening structure configured to fasten the portion of the body of the patient adjacent to the body part to the base body when the portion of the body of the patient adjacent to the body part is received on the surface of the base body.

8. The therapy device of claim 7, wherein the fastening structure has a heel band and an instep band.

9. The therapy device of claim 23, wherein the instep band is connected at two connection spots on two sides of the base body and extends across the surface of the base body, wherein a distance between the two connection spots is adjustable.

10. The therapy device of claim 1, wherein the moving segment comprises a further fastening structure configured to fasten the body part to the moving segment, when the body part is received on the support surface.

11. The therapy device of claim 1, wherein the moving segment and the drive unit are configured to downwardly pivot the moving segment to a maximum of about 50° out of a horizontal plane and to upwardly pivot the moving segment to a maximum of about 30°.

12. The therapy device of claim 1, further comprising a controller coupled to the moving segment and configured to control an extent and speed of the movement of the moving segment.

13. The therapy device of claim 12, wherein the controller is configured to select one of plural predefined therapy programs, wherein each therapy program has a specific combination of extent and speed of movement of the moving segment.

14. The therapy device of claim 12, wherein the controller is magnetically coupled to the moving segment.

15. The therapy device of claim 1, wherein the moving segment comprises a tilting element and a gliding element, and wherein
the drive unit is fixed to the tilting element,
the tilting element is connected or connectable to the base body such that it is pivotable back and forth relative to the base body by the drive unit,
the gliding element comprises the support surface, and
the gliding element is movably mounted to the tilting element.
